(19) United States
(12) Patent Application Publication
(10) Pub. No.: US 2009/0032504 A1
(43) Pub. Date: Feb. 5, 2009

(54) Shielding gas for hybrid welding and welding method using the same

(76) Inventor: Toshikazu Kamei, Kai-shi (JP)

Correspondence Address: NIXON & VANDERHYE, PC, 901 NORTH GLEBE ROAD, 11TH FLOOR, ARLINGTON, VA, 22203, US

(21) Appl. No.: 11/990,918

(22) PCT Filed: Jul. 28, 2006
(86) PCT No.: PCT/JP2006/315063

§ 371 Date: Feb. 25, 2008

(30) Foreign Application Priority Data
Aug. 31, 2005 (JP) 2005-250889

(51) Int. Cl. B23K 26/20

(52) U.S. Cl. 219/121.64

(57) ABSTRACT

The present invention relates to a shielding gas for hybrid welding of a steel plate by combining laser welding and arc welding, characterized by containing: carbon dioxide; and oxygen, in which the mixing ratio of carbon dioxide and oxygen satisfies the following conditions:

15≦A≦35, 1.0≦B≦9.0, and B≧16-0.6 A,

in which A is the volume percentage of carbon dioxide and B is the volume percentage of oxygen.

### TECHNICAL FIELD

The present invention relates to hybrid welding jointly performing laser welding using a laser beam and arc welding using an arc.

Priority is claimed on Japanese Patent Application No. 2005-250889, filed on Aug. 31, 2005, the content of which is incorporated herein by reference.

### BACKGROUND ART

Hybrid welding is a welding method performed by combining laser welding and arc welding. Hybrid welding is a welding method which enables minimization of both the defects of laser welding and the defects of arc welding by combining the characteristics of laser welding which realizes high-sped welding and deep-penetration but has a very expensive thermal source, and the characteristics of arc welding which has only moderately expensive thermal source and let down groove precision standard due to its supplying wire.

As a result, the welding of joints with gaps, which is difficult to perform by laser welding, can be performed, and deep penetration and high-speed welding, which are difficult to perform by arc welding, can be achieved. Thereby, heat-input into the material to be welded can be reduced and deformation caused by welding can be decreased.

However, since a laser beam is used as the thermal source in hybrid welding, the defects of laser welding, such as, for example, the occurrence of blowholes, tend to also occur in hybrid welding.

In hybrid welding, a shielding gas used for arc welding is conventionally used as a shielding gas for masking a molten pool during welding, and a mixed gas prepared by adding carbon dioxide gas or oxygen gas to an inert gas, such as, for example, argon gas or helium gas, is generally used.

As a method for preventing the occurrence of internal defects, such as, for example, blowholes formed by hybrid welding, a welding method in which a mixed gas consisting of helium gas and 10 to 80% argon gas is used as shielding gas is proposed in Patent Document 1.

However, it is difficult to utilize the method except when high added value is created, since helium is an expensive gas. In addition, since no elements that stabilize arc, such as, for example, carbon dioxide gas or oxygen gas, are contained, the droplet transfer process in hybrid welding of steel plate is unstable, and as a result welding defects may occur when hybrid welding a steel plate.

As a method for preventing occurrence of defects in laser welding, such as, for example, blowholes, a method using a mixed gas prepared by adding 2 to 5% by volume of oxygen gas to argon gas is disclosed in Patent Document 2.

The results of experimentation performed by using the mixed gas as a shielding gas in hybrid welding revealed that an addition of only 2 to 5% by volume of oxygen gas does not stabilize the arc and significantly causes both bead shape and internal defects.

As a method for preventing the occurrence of defects in laser welding, such as, for example, blowholes, a method using a mixed gas prepared by adding 80 to 95% by volume of carbon dioxide gas to an inert gas such as argon or the like is disclosed in Patent Document 3.

With respect to the mixed gas, experimentation results revealed that, when the content of the carbon dioxide gas is 50% by volume or more, the total number of internal defects decreases, but blowholes with a diameter of 1.0 mm or more are formed inside welded portions, and the ratio of the cross-sectional area of blowholes with respect to the cross-sectional area of welded portions thereby increases, which is not favorable.

Moreover, even if a mixed gas of argon and carbon dioxide or a mixed gas of argon and oxygen was used in the experiments performed by the present inventors, the mixed gases being generally used as shielding gases in arc welding, the occurrence of internal defects could not be satisfactorily decreased.

### Patent Document 1 Japanese Laid-Open Patent Application, No. 2003-164983

Patent Document 2 Japanese Patent Application, First Publication No. H9-103892

### Patent Document 3 Japanese Laid-Open Patent Application, No. 2001-138085

### DISCLOSURE OF THE INVENTION

### Problems to be Solved by the Invention

An object of the present invention is to provide a shielding gas for hybrid welding which is when a steel plate is welded by a combination of laser welding and arc welding, in which the shielding gas does not cause any internal defects, such as blowholes or the like, in welded portions, the shielding gas stabilizes the arc to realize a favorable bead shape, and the shielding gas can be provided at a low cost.

### Means for Solving the Problems

In order to solve the above-mentioned problems, the present inventors focused on the components of the shielding gas used so as to reduce welding defects, such as blowholes, occurring in hybrid welding. It was found that the use of a mixture composed of three kinds of gas (argon gas, oxygen gas, and carbon dioxide gas) in particular ratios reduces welding defects.

A first aspect of the present invention is a shielding gas for hybrid welding of a steel plate by a combination of laser welding and arc welding, characterized by containing carbon dioxide and oxygen, in which the mixing ratio of carbon dioxide and oxygen satisfies the following conditions:

15≦A≦35, and, 1.0≦B≦9.0, and, B≧16-0.6 A,

in which A is the volume percentage of carbon dioxide and B is the volume percentage of oxygen.

In the shielding gas for hybrid welding of the first aspect, it is more preferable that the mixing ratio of the carbon dioxide and the oxygen satisfy the following conditions:

25≦A≦35, and, B≧8-0.2 A, and, B≦13-0.2 A.

A second aspect of the present invention is a hybrid welding method for welding a steel plate by combining laser welding and arc welding, characterized in that a laser beam, an arc, and the above-mentioned shielding gas are applied to the steel plate.

In the hybrid welding method of the second aspect, it is more preferable that the shielding gas be applied to the steel plate from a coaxial direction relative to an arc, and an assist gas having the same composition as that of the shielding gas be further applied to the steel plate from a progression direction of welding.

The steel plate may be any one selected from the group consisting of cold-reduced carbon steel sheets, hot-rolled steel plates, and rolled steels for welded structures.

### EFFECTS OF THE INVENTION

According to the present invention, it is possible to reduce the surface tension of welded metal, promote the discharge of bubbles present in the bottom of a molten pool, and suppress the occurrence of internal defects (blowholes) in the hybrid welding of a steel plate, by using the shielding gas having the particular above-mentioned composition.

Also, the effects of minimization of unstabilization of arc during welding are exhibited by the presence of an optimum amount of the carbon dioxide.

Although the shielding properties may deteriorate if welding is performed at high speed, separate feeding of the assist gas having the same composition as that of the shielding gas from a progression direction of welding achieves high-shielding properties even if the welding is performed at high speed.

### BRIEF DESCRIPTION OF THE DRAWINGS

FIG. 1 is a skeleton framework illustrating the main parts of a welding apparatus used for hybrid welding according to the present invention.

FIG. 2 is a diagram illustrating the range of the mixing ratio of oxygen and carbon dioxide in the shielding gas according to the present invention.

### BRIEF DESCRIPTION OF THE REFERENCE SYMBOLS

1. Laser head
3. Steel plate
4. Arc torch
5. Wire
6. End-member

### BEST MODE FOR CARRYING OUT THE INVENTION

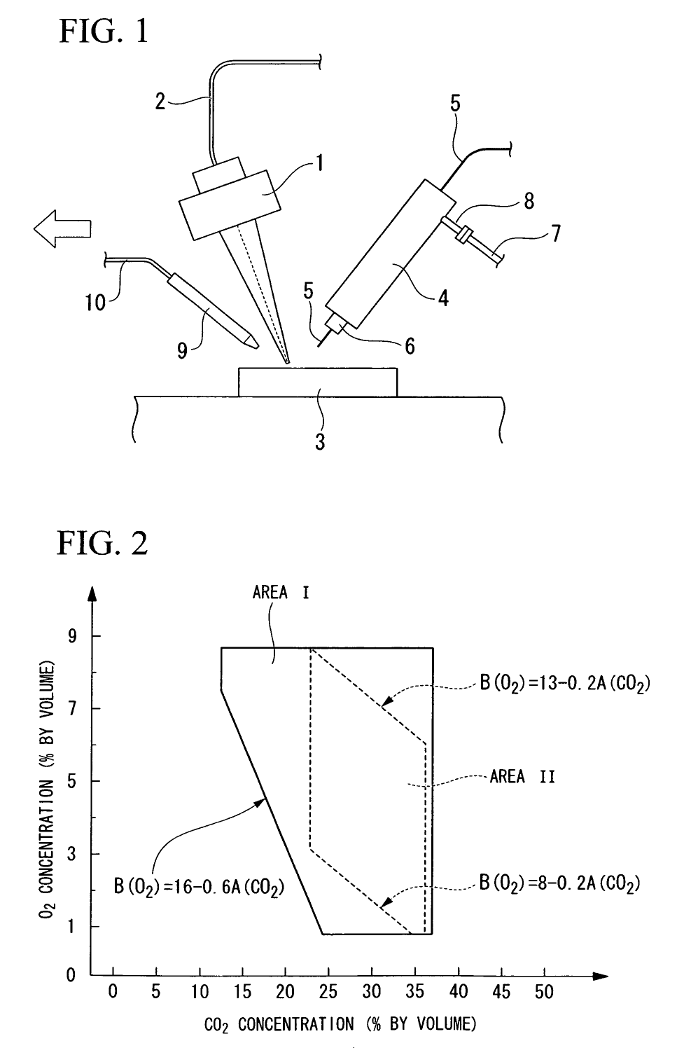

FIG. 1 illustrates the main parts of an embodiment of a welding apparatus used in the hybrid welding method according to the present invention, and the numeral “1” therein illustrates a laser head. In the laser head 1, optical lenses such as a condenser or the like are held. A laser beam with a wave length of 1.064 μm enters the laser head 1, after being guided through an optical fiber 2 from a laser beam source (now shown) such as, for example, a YAG (Nd) laser oscillator. The laser beam is condensed therein and emitted in a beam state onto a welded portion of a steel plate 3.

The numeral “4” illustrates an arc torch. Into the arc torch 4, a wire 5 is fed from a wire-feeding device (not shown), and an end portion of the wire 5 protrudes from an end-member 6 of the arc torch 4 toward the welded portion, and serves as a welding tip.

Moreover, a nozzle for ejecting a shielding gas from an outer circumference of the wire 5 is formed at the end-member 6 so that the shielding gas fed from a shielding gas source (not shown) through a pipe 7 to a shielding gas inlet 8 of the arc torch 4 is ejected from the nozzle of the end-member 6 toward the welded portion.

The wire 5 is connected to a welding electric source through the wire-feeding device (not shown), so that an arc is discharged from the end portion of the wire 5 toward the welded portion. The arrow in FIG. 1 illustrates the progressing direction of welding.

In addition, the numeral “9” in the figure illustrates an assist gas nozzle. The assist gas nozzle 9 is placed before the arc with respect to a progression direction of welding and connected to an assist gas source (which is not shown in the figure) through a pipe 10 so that an assist gas is able to be ejected from an end thereof toward the welded portion of the steel plate 3.

As shown in FIG. 1, each of a central axis of the arc torch 4, an optical axis of the laser beam, and a central axis of the assist gas nozzle 9 is positioned at an angle to the vertical plane so as to minimize interference between the arc and the laser beam, and so that the angle of the arc torch 4, the axis of the laser beam, and the angle of the assist gas nozzle 9 are opposed to each other.

Next, a method for hybrid welding of the steel plate using the welding apparatus will be explained.

The steel plate is preferably a cold-reduced carbon steel sheet, a hot-rolled steel plate, or rolled steel for welded structure.

From the laser head 1, a laser beam with a wave length of 1.064 μm and an output power of 1 to 20 kW is emitted towards a welded portion of the steel plate 3. A YAG (Yb) laser with a wave length of 1.03 μm, a carbon dioxide gas laser with a wave length of 10.6 μm, or a semiconductor laser with a wave length of 0.8 μm or 0.95 μm may also be used.

A direct current is applied to the wire 5 of the arc torch 4 to discharge the arc from the end portion of the wire 5 toward the welded portion. At the same time, the shielding gas is ejected from the nozzle of the end-member 6 of the arc torch 4 toward the welded portion.

The shielding gas is composed of a mixture of argon, carbon dioxide, and oxygen. The ratio of carbon dioxide and oxygen is adjusted to be within the following range:

15≦A≦35, and, 1.0≦B<9.0, and, B≧16-0.6 A,

preferably within the following range:

25≦A≦35, and, B≧8-0.2 A, and, B≦13-0.2 A,

in which A is the volume percentage of carbon dioxide, and B is the volume percentage of oxygen.

By adjusting the ratio of carbon dioxide and oxygen in the shielding gas to be within the above-mentioned range, the arc stability is maintained, the welding activity is made to be excellent, and the occurrence of internal defects (blowholes, pits, or the like) at the welded portion is minimized.

FIG. 2 illustrates the carbon dioxide and oxygen concentration range in the shielding gas. The area surrounded by a solid line (Area I) illustrates the range satisfying the following conditions:

15≦A≦35, and, 1.0≦B<9.0, and, B≧16-0.6 A,

and the area surrounded by the dashed line (Area II) illustrates the range satisfying the following conditions:

25≦A≦35, and, B≧8-0.2 A, and, B≦13-0.2 A.

As is demonstrated by the following examples, the number of blowholes formed per 100 mm welded length is reduced to less than 25 by using a shielding gas having a composition falling within Area I, and the number of blowholes formed per 100 mm welded length is reduced to 10 or less by using a shielding gas having a composition falling within Area II.

As is demonstrated by the following examples, the ratio of carbon dioxide and oxygen in the shielding gas according to the present invention was determined by the actual performance of welding and the evaluation thereof, and the actual number of defects in the welded portions.

The ejection-flow-rate of the shielding gas is generally approximately 10 to 30 liters per minute.

When welding is performed at a high rate, such as 200 cm per minute or more, an assist gas is preferably ejected from the assist gas nozzle 9 toward the welded portion. As the assist gas, a gas having the same composition as that of the shielding gas is used, and the flow rate thereof may be approximately 10 to 40 liter per minute.

Although there is a possibility in which shielding of a molten pool by the shielding gas is disturbed and the shielding properties deteriorate if the welding speed is high, the feeding of the assist gas prevents the deterioration of the shielding properties and achieves favorable shielding even during high-speed welding.

### EXAMPLES

### Examples and Comparative Examples

Hybrid welding using a shielding gas was performed using the welding apparatus shown in FIG. 1.

Welding was performed by bead-on-plate welding under the following conditions. The shielding gas was fed from an arc torch. As the material to be welded, a steel plate (SPCC) with a thickness of 3.2 mm was used. A mixed gas of three components (argon, oxygen, and carbon dioxide) was used as a shielding gas. These three components were mixed at various ratios to obtain a large number of shielding gases with different compositions.

The optimum mixing ratio of oxygen and carbon dioxide in the shielding gas was experimentally determined based on the number of internal defects at each welded portion.

The range of the mixing ratio suitable for hybrid welding was determined in view of the occurrence of internal defects (such as blowholes, pits, or the like) and stability of the arc at the time of performing hybrid welding under the following welding conditions.

The range in which the number of internal defects (blowholes) occurred was less than half (25 defects) that of when the generally used shielding gas (argon gas with 20% carbon dioxide gas) for arc welding was used (49 blowholes occurred), in which arc was stabilized, and in which no pits were formed, was determined as the range suitable for hybrid welding (Area I). In addition, the concentration range in which the number of blowholes was no more than one-fifth (10 blowholes) that of when the generally used shielding gas (argon gas with 20% carbon dioxide gas) was used was determined as a more preferable range (Area II).

The welding conditions were as follows.

Arc welding: MAG-welding

Welding speed: 1.0 m/min

Distance between tip and base metal: 15 mm

Laser output power (YAG laser): 2.0 kW

Welding current: 150 A

Flow rate of shielding gas: 20 l/min

Welding was performed for a distance of 100 mm, and the number of blowholes, the blowhole size, the existence of pits, and the stability of the arc were evaluated. The results thereof are shown in Tables 1 and 2.

TABLE 1

| Concen- | Concen- | | | |
|---|---|---|---|---|
| tration | tration | Number of | | Eval- |
| of O₂ | of CO₂ | blowholes | Others | uation |
| 1.0 | 0 | 100 | Arc was unstable. | X |
| 3.0 | 0 | 135 | Arc was unstable. | X |
| 5.0 | 0 | 75 | Arc was unstable. | X |
| 7.0 | 0 | 64 | Arc was unstable. | X |
| 9.0 | 0 | — | Arc was unstable and | X |
| | | | impossible to weld. | |
| 0 | 10 | 46 | Many blowholes were formed. | X |
| 5.0 | 10 | 30 | Many blowholes were formed. | X |
| 7.0 | 10 | 28 | Many blowholes were formed. | X |
| 9.0 | 10 | 32 | Pits were formed and | X |
| | | | blowhole-size was 1.0 mm or | |
| | | | more. | |
| 5.0 | 15 | 29 | Many blowholes were formed. | X |
| 6.0 | 15 | 45 | Many blowholes were formed. | X |
| 7.0 | 15 | 17 | | ◯ |
| 8.0 | 15 | 22 | | ◯ |
| 9.0 | 15 | 84 | Pits were formed and | X |
| | | | blowhole-size was 1.0 mm or | |
| | | | more. | |
| 0 | 20 | 49 | Many blowholes were formed. | X |
| 1.0 | 20 | 43 | Many blowholes were formed. | X |
| 3.0 | 20 | 25 | Many blowholes were formed. | X |
| 4.0 | 20 | 12 | | ◯ |
| 5.0 | 20 | 20 | | ◯ |
| 7.0 | 20 | 16 | | ◯ |
| 8.0 | 20 | 17 | | ◯ |
| 9.0 | 20 | 17 | Pits were formed and | X |
| | | | blowhole-size was 1.0 mm or | |
| | | | more. | |

TABLE 2

| Concen- | Concen- | | | |
|---|---|---|---|---|
| tration | tration | Number of | | Eval- |
| of O₂ | of CO₂ | blowholes | Others | uation |
| 0 | 25 | 32 | Many blowholes were formed. | X |
| 1.0 | 25 | 20 | | ◯ |
| 2.0 | 25 | 19 | | ◯ |
| 3.0 | 25 | 10 | | ⊚ |
| 5.0 | 25 | 7 | | ⊚ |
| 7.0 | 25 | 8 | | ⊚ |
| 8.0 | 25 | 10 | | ⊚ |
| 9.0 | 25 | 17 | Pits were formed and | X |
| | | | blowhole-size | |
| | | | was 1.0 mm or more. | |
| 0 | 30 | 28 | Many blowholes were formed. | X |
| 1.0 | 30 | 15 | | ◯ |
| 3.0 | 30 | 10 | | ⊚ |
| 5.0 | 30 | 8 | | ⊚ |
| 7.0 | 30 | 9 | | ⊚ |
| 8.0 | 30 | 12 | | ◯ |
| 9.0 | 30 | 33 | Pits were formed and | X |
| | | | blowhole-size | |
| | | | was 1.0 mm or more. | |
| 0 | 35 | 29 | Many blowholes were formed. | X |
| 1.0 | 35 | 7 | | ⊚ |
| 3.0 | 35 | 9 | | ⊚ |
| 5.0 | 35 | 9 | | ⊚ |
| 6.0 | 35 | 10 | | ⊚ |
| 7.0 | 35 | 14 | | ◯ |
| 8.0 | 35 | 24 | | ◯ |
| 9.0 | 35 | 25 | Pits were formed and | X |
| | | | blowhole-size | |
| | | | was 1.0 mm or more. | |
| 0 | 40 | 27 | Many blowholes were formed. | X |
| 1.0 | 40 | 35 | Many blowholes were formed. | X |
| 3.0 | 40 | 27 | Pits were formed and | X |
| | | | blowhole-size | |
| | | | was 1.0 mm or more. | |
| 5.0 | 40 | 67 | Pits were formed and | X |
| | | | blowhole-size | |
| | | | was 1.0 mm or more. | |
| 7.0 | 40 | 39 | Pits were formed and | X |
| | | | blowhole-size | |
| | | | was 1.0 mm or more. | |
| 9.0 | 40 | 23 | Pits were formed and | X |
| | | | blowhole-size | |
| | | | was 1.0 mm or more. | |
| 0 | 50 | 14 | Pits were formed and | X |
| | | | blowhole-size | |
| | | | was 1.0 mm or more. | |
| 1.0 | 50 | 19 | Pits were formed and | X |
| | | | blowhole-size | |
| | | | was 1.0 mm or more. | |

In Tables 1 and 2, x represents a case where at least one of the following occurred: the arc was unstable, pits formed, the blowhole size was 1.0 mm or more, and the number of blowholes formed was 25 or more; ◯ represents a case in which the number of blowholes formed was less than 25; and ⊚ represents a case in which the number of blowholes formed was less than 10.

The evaluation results of Tables 1 and 2 were plotted on a graph, and the area in which gas compositions with the evaluation result of “◯” or “⊚” exist are marked as Area I in FIG. 2, and the area in which gas compositions with the evaluation result of “⊚” exist are marked as Area II in FIG. 2.

Then, the above-mentioned relationship was determined from the Areas I and II.

### Reference Example

In order to confirm the effects of the present invention, conventional laser welding and arc welding were performed and the number of blowholes was evaluated per 100 mm of welded distance.

The material to be welded, the welding speed, the laser output power, the welding current, and the distance between the tip and the base metal were the same as those of the above-mentioned examples.

Laser Welding

Welding speed: 1.0 m/min

Laser output power: 2.0 kW

Shielding gas: Ar (gas generally used for laser welding)

Flow rate of shielding gas: 40 l/min

Arc Welding

Welding speed: 1.0 m/min

Distance between tip and base metal: 15 mm

Welding current: 150 A

Shielding gas: Ar-20% CO₂ (gas generally used for arc welding)

Flow rate of shielding gas: 20 l/min Results are shown in Table 3. In Table 3, the results of hybrid welding performed by using a generally used shielding gas composed of Ar and 20% CO₂ for arc welding are also shown.

TABLE 3

| Welding process | Shielding gas | Number of blowholes |
|---|---|---|
| Laser welding | Ar | 125 |
| Arc welding | Ar—20%CO₂ | 1.5 |
| Hybrid welding | Ar—20%CO₂ | 49 |

Results shown in Table 3 revealed that hybrid welding using the generally used shielding gas (Ar-20% CO₂) for arc welding resulted in 49 blowholes. In other words, it was revealed that the use of the shielding gas according to the present invention decreases the occurrence of blowholes in hybrid welding to half or less, more preferably to one-fifth or less, of that when generally used shielding gas was used.

### INDUSTRIAL APPLICABILITY

According to the present invention, it is possible to reduce the surface tension of the steel plate, promote discharging of bubbles present in the bottom of a molten pool, and suppress the occurrence of internal defects (blowholes or the like) in hybrid welding of the steel plate, by using a shielding gas having the particular composition mentioned above.

The minimization of unstabilization of the arc during welding is also exhibited by the presence of an optimum amount of the carbon dioxide.

Although the shielding properties may decrease if welding is performed at high speed, separate feeding of an assist gas having the same composition as that of the shielding gas from a progression direction of welding achieves high-shielding properties even if the welding is performed at high speed.

1. A shielding gas for hybrid welding of a steel plate by combining laser welding and arc welding, characterized by comprising: carbon dioxide; and oxygen, in which a mixing ratio of carbon dioxide and oxygen satisfies the following conditions:
15≦A≦35, and, 1.0≦B≦9.0, and, B≧16-0.6 A,
in which A is the volume percentage of carbon dioxide and B is the volume percentage of oxygen.

2. The shielding gas for hybrid welding according to claim 1, characterized in that the mixing ratio of the carbon dioxide and the oxygen satisfies the following conditions:
25≦A≦35, and, B≧8-0.2 A, and, B≦3-0.2 A.

3. A hybrid welding method for welding a steel plate by combining laser welding and are welding, characterized in that a laser beam, an are, and the shielding gas of claim 1, are applied to the steel plate.

4. The hybrid welding method according to claim 3, characterized in that the shielding gas is applied to the steel plate from a coaxial direction relative to an arc, and an assist gas having the same composition as that of the shielding gas is further applied to the steel plate from a progression direction of welding.

5. The hybrid welding method according to claim 3, characterized in that the steel plate is any one selected from the group consisting of cold-reduced carbon steel sheets, hot-rolled steel plates, and rolled steels for a welded structure.
